(19) United States
(12) Patent Application Publication
(10) Pub. No.: US 2006/0163848 A1
(43) Pub. Date: Jul. 27, 2006

(54) Airbag and airbag apparatus

(75) Inventor: Kazuhiro Abe, Tokyo (JP)

Correspondence Address: KANESAKA BERNER AND PARTNERS LLP, SUITE 300, 1700 DIAGONAL RD, ALEXANDRIA, VA, 22314-2848, US

(73) Assignee: TAKATA CORPORATION, Tokyo (JP)

(21) Appl. No.: 11/297,422

(22) Filed: Dec. 9, 2005

(30) Foreign Application Priority Data
Jan. 26, 2005 (JP) 2005-018538

(51) Int. Cl. B60R 21/231; B60R 21/233

(52) U.S. Cl. 280/729; 280/730.1; 280/731

(57) ABSTRACT

An airbag of an airbag apparatus includes an airbag main body capable of expanding in a manner such that the airbag main body covers a steering wheel in front of a driver seated in a driver-side seat, and an upper extending portion that covers a vehicle roof pillar by extending upward from above a left or right side of the airbag main body. The airbag apparatus is designed so as to maintain the airbag shape and position even when the steering wheel is rotated. In the event of an oblique collision, the airbag is capable of preventing a head region of a driver from colliding with the pillar, yet without excessively increasing the required airbag volume.

### BACKGROUND OF THE INVENTION AND RELATED ART STATEMENT

The present invention relates to an airbag and an airbag apparatus attached to a motor vehicle or the like, and more specifically relates to an airbag and an airbag apparatus configured to prevent a head region of an occupant from colliding with a pillar of the motor vehicle.

An airbag for protecting an occupant seated on a driver's seat, a passenger seat, or a rear seat of a motor vehicle, in the event of a crash of the motor vehicle, is known. When the volume of the airbag is increased, most of a head region and an upper half of the body of the occupant can be caught by the airbag, however, a large gas-generation volume is required for an inflator.

A passenger airbag that prevents the head region of the occupant from colliding with a pillar of the motor vehicle and that attempts to minimize gas volume is described in U.S. Pat. No. 4,474,390. FIG. 6 illustrates the airbag described in U.S. Pat. No. 4,474,390, in which an airbag apparatus is attached to an instrument panel 2 of the motor vehicle 1, and the airbag 3 is extended between the instrument panel 2 and the passenger seat in a vertical direction.

A front face of the airbag 3 faces an occupant seated on the passenger seat and serves as a colliding-face for the occupant that catches the occupant seated on the passenger seat in the event of a crash of the motor vehicle. At a rear face of the airbag 3, a gas in-flow inlet 4 is provided.

The airbag 3 has an inverted trapezoid shape. That is, the lower the position one moves from an upper part to a lower part, the smaller a width of the airbag (the width of the airbag in a left-and-right direction of the vehicle body of the motor vehicle 1) becomes. Therefore, the volume of a lower portion of the airbag is small. A side 6 of the upper portion of the airbag 3 prevents the occupant seated on the passenger seat from directly colliding with a front pillar 7, in the event of an oblique crash of the motor vehicle 1.

An upper portion of the airbag described in U.S. Pat. No. 4,474,390 laterally overhangs. Therefore, in the event of an oblique crash of the motor vehicle, and when an occupant moves in a manner stretching upward in an obliquely forward direction, there is a possibility that a head region of the occupant collides with a pillar, overleaping the lateral overhanging portion of the airbag. In the airbag having increased lengths in an upper-and-lower direction and a left-and-right direction for preventing the above problem, the volume of the airbag becomes excessive.

Accordingly, it is an object of the present invention to provide an airbag and an airbag apparatus capable of preventing the head region of the occupant from colliding with the pillar in the event of an oblique crash of the motor vehicle, yet without increasing the volume of the airbag.

Further objects and advantages of the invention will be apparent from the following description of the invention and the associated drawings.

### SUMMARY OF THE INVENTION

An airbag according to one embodiment of the present invention is provided in front of a seat of a motor vehicle and includes an airbag main body configured to be expanded in front of an occupant, and an upper extending portion configured to extend upward from above a left or a right side of the airbag main body.

The airbag has an extending length L of the upper extending portion from the airbag main body, which, when expanded in a direction parallel to an axial direction of a steering column, is determined to be from 50 to 400 mm.

The airbag includes a device for limiting a thickness of the upper extending portion, when the upper extending portion is expanded.

The airbag is for use in a front seat, and the upper extending portion is configured to be slanting toward a backside of the motor vehicle, when the airbag is expanded.

The upper extending portion is configured to be slanting toward the backside of the motor vehicle, when the airbag is expanded, by connecting the upper extending portion on the occupant side to the airbag main body on the occupant side with a tether belt.

In another embodiment of the invention, an airbag apparatus includes an airbag according to the above-described embodiment of the invention, and an inflator for expanding the airbag.

In one embodiment of the airbag apparatus, the airbag apparatus is for use in a driver-side seat, and is configured not to change a posture thereof, even when a steering wheel is rotated.

In the airbag according to the invention, the upper extending portion is extended upward from above a left or a right side of the airbag main body. Because the upper extending portion, when the airbag is expanded, is extended upward along the pillar and covers the pillar, a head region of the occupant is prevented from colliding with the pillar, even when the occupant moves upward in an obliquely forward direction.

Particularly, by determining the extending length L of the upper extending portion from the airbag main body, when expanded, in the direction parallel to the axial direction of the steering column to be from 50 to 400 mm, the head region of the occupant is sufficiently prevented from colliding with the pillar.

When the thickness of the upper extending portion, when expanded, is limited, the volume of the airbag can be reduced to that extent. In addition, the upper extending portion is designed to have a flat or nearly flat shape facing the occupant, and the upper extending portion can be widely expanded. Accordingly, the pillar is covered by the upper extending portion.

Further, the A pillar of a motor vehicle is usually slanting toward the backside thereof. Therefore, in the airbag for use in a front-side seat, the upper extending portion is preferably configured, when expanded, in a manner so as to be slanting toward the backside of the motor vehicle.

By connecting the upper extending portion on the occupant side to the airbag main body on the occupant side with the tether belt, the upper extending portion can be expanded in a manner so as to be slanting toward the backside of the vehicle.

When the airbag apparatus is applied for use in a driver-side seat, the airbag apparatus is configured so as to not change the posture (i.e., shape and position) thereof, even when a steering wheel is rotated. As a result, even when the motor vehicle is crashed while moving through a curve, the upper extending portion is reliably expanded along the A pillar.

### BRIEF DESCRIPTION OF THE DRAWINGS

FIG. 1 is a perspective view illustrating an expanded state of an airbag according to one embodiment of the invention.

FIG. 2(a) is a vertical cross-section illustrating a first state when the airbag is expanded.

FIG. 2(b) is a vertical cross-section illustrating a second state when the airbag is expanded.

FIG. 3 is a plan view illustrating the airbag.

FIG. 4 is a side view illustrating an interior of a motor vehicle when the airbag is expanded.

FIG. 5 is a perspective view illustrating a state when an upper extending portion of the airbag catches a head region of an occupant.

FIG. 6 is a perspective view of a conventional airbag.

### DETAILED DESCRIPTION OF THE PREFERRED EMBODIMENTS

The embodiments of the present invention will be described below with reference to the accompanying drawings.

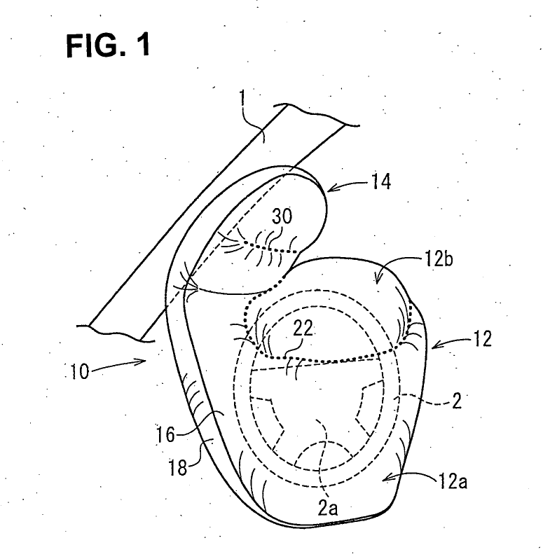

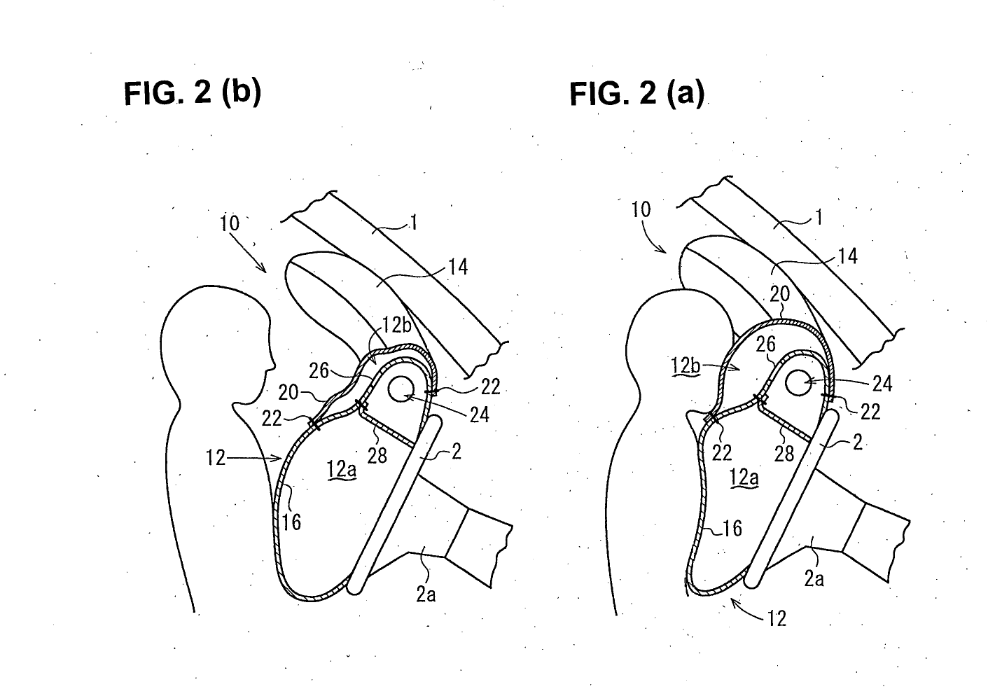

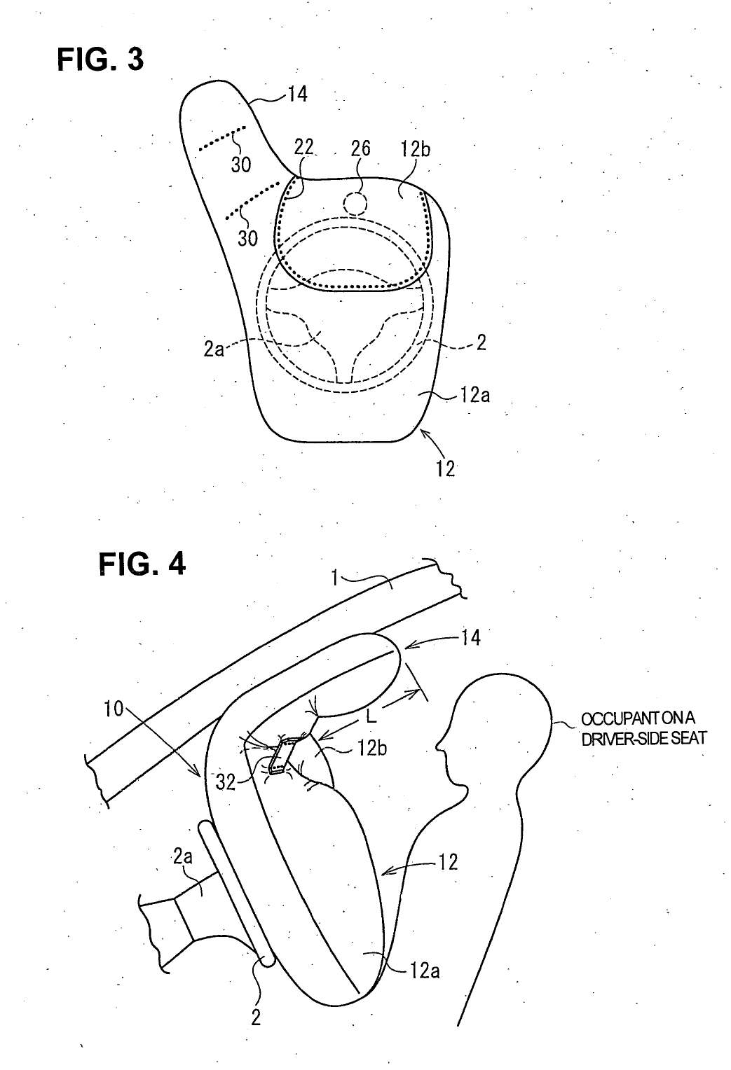

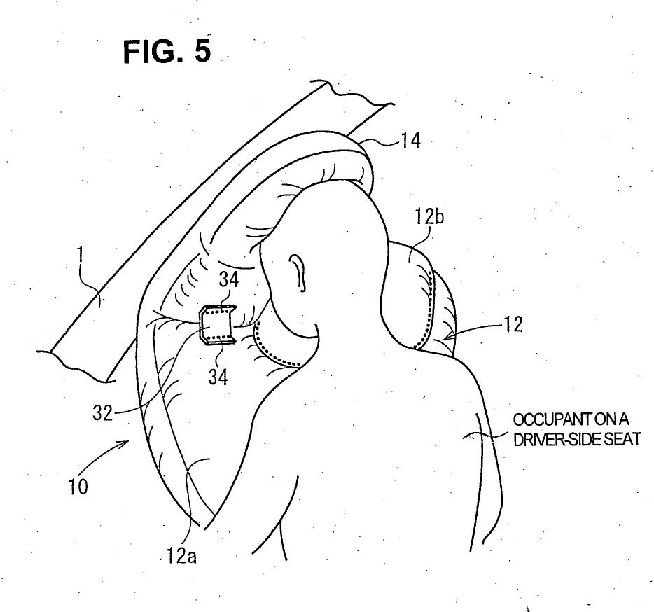

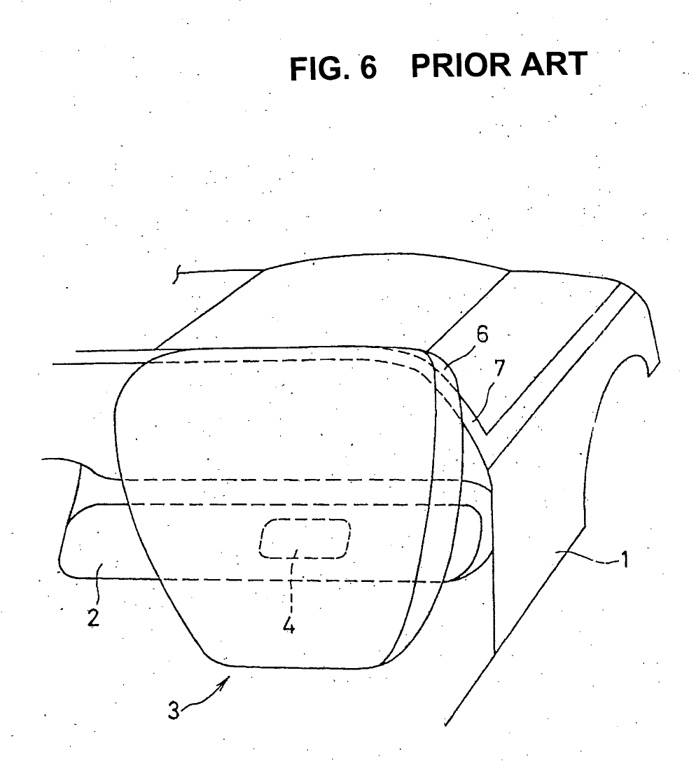

FIG. 1 is a perspective view illustrating an embodiment of an airbag, when expanded; FIG. 2(a) is a vertical cross-section illustrating the airbag, when a first chamber thereof is expanded; FIG. 2(b) is a vertical cross-section illustrating the airbag when a second chamber thereof is expanded; FIG. 3 is a plan view of the airbag; FIG. 4 is a side view of an interior of a motor vehicle when the airbag is expanded; and FIG. 5 is a perspective view of the airbag when an upper extending portion thereof catches a head region of an occupant.

In this embodiment, an airbag 10 is the driver-side airbag mounted on a driver-side airbag apparatus of the motor vehicle. The driver-side airbag apparatus is provided with the airbag 10, a retainer (not shown), to which the airbag 10 is attached, a gas-generator (not shown) for expanding the airbag 10, and a module cover (not shown) for covering the folded airbag 10. The driver-side airbag apparatus is disposed at an occupant side of a central portion 2a of a steering wheel 2.

Further, in this embodiment, a driver's seat is located in the left side of the front row in the motor vehicle and an A pillar 1 is disposed in front of the driver's seat on the oblique left. The A pillar 1 is slanting toward a backside of the motor vehicle, as shown in FIG. 4.

The airbag 10 is provided with an airbag main body 12 that is expanded in a manner to cover the steering wheel 2 in front of the occupant seated on the driver's seat, and an upper extending portion 14 that covers the A pillar 1 by upwardly extending from the upper part of the left side of the airbag main body 12.

An extending length L of the upper extending portion 14 from the airbag main body 12, when expanded, in a direction parallel to an axial direction of a steering column, is preferably determined to be from 50 to 400 mm, particularly from 150 to 400 mm, and more particularly from 200 to 400 mm.

As shown in FIG. 3, the airbag main body 12 is expanded such that a side peripheral portion thereof overhangs an outer periphery of the steering wheel 2 (in a radial direction). Further, in this embodiment, the amount of overhang of the airbag main body 12 from both a left and a right side part of the outer periphery of the steering wheel 2 in the expanded state of the airbag main body 12 is less than the amount of overhang from an upper end portion and a lower end portion of the outer periphery of the steering wheel 2.

In this embodiment, the airbag 10 is formed by stitching a front main panel 16 composed of a series of a surface of the airbag main body 12 on an occupant side and a surface of the upper extending portion 14 on an occupant side, a rear panel 18 composed of a series of a surface of the airbag main body 12 on a steering wheel side and a surface of the upper extending portion 14 on a steering wheel side, and an upper panel 20 disposed at an upper part of the airbag main body 12 on an occupant side together.

The front main panel 16 and the rear panel 18 are the panels having substantially the same shape and each of respective peripheral edge portions are combined together by a seam (not shown) formed with a thread or the like. The upper panel 20 is overlapped with the front main panel 16 on an occupant side at an upper part of the airbag main body 12, and a peripheral edge portion of the upper panel 20 is combined with the front main panel 16 by a seam 22.

An internal part of the airbag main body 12 is partitioned into a first chamber 12a and a second chamber 12b by the front main panel 16, the rear panel 18, and the upper panel 20. The first chamber 12a is a chamber surrounded by the front main panel 16 and the rear panel 18 and the second chamber 12b is a chamber surrounded by the front main panel 16 and the upper panel 20.

In the vicinity of a center of the airbag main body 12 on a steering wheel 2 side, a gas inlet (not shown) for receiving gas from the gas generator is provided. The gas inlet communicates with internal space of the first chamber 12a.

At both a left and a right side of the second chamber 12b, a communication opening 24 that allows the first chamber 12a to communicate with the second chamber 12b (refer to FIGS. 2(a) and 2(b)) is formed. Further, in the vicinity of a center of the second chamber 12b in a left-and-right direction, a vent hole 26 for allowing the gas in the second chamber 12b to be discharged into the first chamber 12a, when the expanded second chamber 12b catches the occupant, is formed. In addition, although not shown, a vent hole for allowing the gas in the first chamber 12a to be discharged is formed in the airbag main body 12.

Further, in this embodiment, the front main panel 16 and the rear panel 18 are combined together by a tether belt 28 at the upper part of the airbag main body 12. Thereby, a thickness of an upper part of the first chamber 12a, when expanded, is limited.

Furthermore, in this embodiment, in the upper extending portion 14, the front main panel 16 and the rear panel 18 are also combined by a tether belt (not shown). In this embodiment, the tether belt is provided at two positions along an extending direction of the upper extending portion 14. A numeral 30 in FIG. 3 denotes a seam that stitches an end of the tether belt in the upper extending portion 14 on the front main panel 16. By the tether belt, the upper extending portion 14 is made to have a flat shape widened in a left-and-right direction, when expanded.

In this embodiment, the upper extending portion 14 on the occupant side, when expanded, is connected to the airbag main body 12 on the occupant side by a tether belt 32 in a manner such that the upper extending portion 14 is slanting toward the backside of the motor vehicle. A numeral 34 (in FIG. 5) denotes a seam that combines each of both ends of the tether belt 32 with the front main panel 16.

In the airbag 10, a peripheral edge portion of the gas inlet is connected to the retainer. In addition, the gas generator is attached to the retainer to allow the gas to be supplied into the airbag 10 through the gas inlet. Further, the airbag 10 is folded and the module cover is attached in a manner to cover the airbag 10, and thus the airbag apparatus is configured.

In this embodiment, an attaching base (not shown) whose posture is not changed, even when the steering wheel 2 is rotated, is provided in the central portion 2a of the steering wheel 2. A configuration of the attaching base is not particularly limited. For example, the attaching base may be configured in a manner not to connect to the steering wheel 2 and to connect to a non-rotating member, such as steering column housing or the like, through a connecting member, or other configuration may be applicable.

The airbag apparatus is attached to the attaching base and is configured not to change the posture, even when the steering wheel 2 is rotated.

When a motor vehicle, on which the thus configured airbag apparatus for use in a driver-side seat is mounted, is crashed, the gas generator activates, and the gas is blown out and supplied into the airbag 10. The airbag 10 starts to be expanded by the gas, and pushing open the module cover, the airbag 10 is expanded in front of the occupant seated on the driver-side seat.

In this embodiment, because the gas blown out from the gas generator is delivered into the first chamber 12a, the airbag 10 is largely expanded from a central portion of the airbag main body 12 to a lower part thereof first, as shown in FIG. 2(a). In addition, because an internal volume of the first chamber 12a is small in comparison with an entire volume of the airbag 10 and an expansion of the upper part of the first chamber 12a toward the occupant side is limited by the tether belt 28, the airbag main body 12 is immediately expanded from the central part to the lower part thereof. Therefore, a chest region or an abdominal region of the occupant seated on the driver-side seat is first caught by the airbag 10 (airbag main body 12).

The gas delivered into the first chamber 12a reaches an upper left part of the airbag main body 12 and flows into the upper extending portion 14 and flows into the second chamber 12b passing through each of the communication openings 24. As a result, each of the upper part of the airbag main body 12 and the upper extending portion 14 is also expanded. The upper extending portion 14 starts to be protrudingly expanded upward along the A pillar 1 from an upper left part of the airbag main body 12 and covers the A pillar 1.

Further, in this embodiment, because a thickness of the upper extending portion 14 is limited by the tether belt, the upper extending portion 14 is also immediately expanded. Furthermore, at this moment, because the upper extending portion 14 is expanded in a manner such that it is slanting toward the backside of the motor vehicle by being pulled by the tether belt 32, the upper extending portion 14 is brought to smoothly cover the A pillar 1.

When the head region of the occupant moves straight toward approximately the front side, the head region is caught by an upper part of the expanded airbag main body 12 (the second chamber 12b) and thereby, the head region of the occupant is prevented from colliding with a member existing in front of the seat, such as the steering wheel 2 or the like.

Further, even when the head region of the occupant moves upward in an obliquely left frontward direction, because the expanded upper extending portion 14 covers the A pillar 1, the head region of the occupant is caught by the upper extending portion 14 and the head region of the occupant is prevented from colliding with the A pillar 1.

Furthermore, in this embodiment, by designing the extending length L of the upper extending portion 14 from the airbag main body, when expanded, in the direction parallel to the axial direction of the steering column to be equal to or greater than 50 mm, the head region of the occupant is sufficiently prevented from colliding with the A pillar 1. In addition, because the extending length L of the upper extending portion 14 from the airbag main body is designed to be 400 mm or less, an interference of the upper extending portion 14 with a roof part of the motor vehicle can be suppressed.

Furthermore, in this embodiment, because the thickness of the upper extending portion 14, when expanded, is limited by the tether belt, part of the upper extending portion 14 facing the occupant is brought to have a flat shape or nearly the same shape. As a result, the upper extending portion 14 is widely expanded and the A pillar 1 is brought to be widely covered with the upper extending portion 14.

In this embodiment, because the airbag apparatus is configured not to change the posture thereof even when the steering wheel 2 is rotated, even when the motor vehicle is crashed, while moving through a curve, the upper extending portion 14 is reliably expanded along the A pillar 1.

The above-described embodiments are illustrative of the invention, and are not to be construed as limiting the invention.

For example, in the above-described embodiment, because the pillar is disposed at a left side in front of the seat, the upper extending portion is provided at an upper left part of the airbag main body. However, when a pillar is disposed at a right side in front of the seat, the upper extending portion is provided at an upper right part of the airbag main body.

In this embodiment, an example of applying the present invention to the airbag apparatus for use in the driver-side seat is described. However, the present invention can be also applied to the airbag apparatus for use in a passenger seat or the seat at a row behind the driver-side seat and the passenger seat.

The disclosure of Japanese Patent Application No. 2005-018538 filed on Jan. 26, 2005, is incorporated herein.

What is claimed is:

1. An airbag mounted on an airbag apparatus provided in front of a seat of a motor vehicle, said airbag comprising:
an airbag main body configured to be expanded in front of an occupant; and
an upper extending portion configured to extend upward from above a left or a right side of the airbag main body.

2. The airbag according to claim 1, wherein an extending length L of the upper extending portion from the airbag main body, when expanded, in a direction parallel to an axial direction of a steering column, is from 50 to 400 mm.

3. The airbag according to claim 2, wherein the extending length L is from 150 to 400 mm.

4. The airbag according to claim 3, wherein the extending length L is from 200 to 400 mm.

5. The airbag according to claim 1, further comprising a device for limiting a thickness of the upper extending portion when the upper extending portion is expanded.

6. The airbag according to claim 1, wherein the airbag is for use in a front seat, and the upper extending portion is configured to be slanting upwardly and backwardly of the motor vehicle, when the airbag is expanded.

7. The airbag according to claim 6, further comprising a tether belt connecting the upper extending portion on an occupant side to the airbag main body on an occupant side for the providing the slanting expanded upper extending portion.

8. The airbag according to claim 7, wherein the tether belt provides the expanded upper extending portion with a flat shape widened in a left-and-right direction.

9. The airbag according to claim 8, wherein said airbag main body includes a first chamber to be connected to the inflator, and a second chamber separated from the first chamber to cover an upper front portion of the first chamber, said first chamber communicating with said upper extending portion and the second chamber.

10. An airbag apparatus comprising:
an airbag; and
an inflator for expanding the airbag,
wherein the airbag is the airbag according to claim 1.

11. The airbag apparatus according to claim 9, wherein the airbag apparatus is for use in a driver-side seat, and includes a mechanism for maintaining the airbag shape and position even when a steering wheel is rotated.
